(19) United States
(12) Patent Application Publication
(10) Pub. No.: US 2013/0211914 A1
(43) Pub. Date: Aug. 15, 2013

(54) Realtime advertising for search results

(71) Applicants: Nagareddy S. Reddy, Sammamish, WA (US); Harsh Chiplonkar, Issaquah, WA (US)

(72) Inventors: Nagareddy S. Reddy, Sammamish, WA (US); Harsh Chiplonkar, Issaquah, WA (US)

(73) Assignee: MICROSOFT CORPORATION, Redmond, WA (US)

(21) Appl. No.: 13/372,532

(22) Filed: Feb. 14, 2012

(51) Int. Cl. G06Q 30/02

(52) U.S. Cl. 705/14.54

(57) ABSTRACT

Architecture that enables the realtime selection and application of advertisements to search results of a user based on the user intent. The architecture enables information exchange between the search engine and advertisement frameworks to provide significant input for realtime advertising decisions. Each query processed in the search engine is analyzed and classified for user intent. Realtime intent classification enables merchants to choose to place or not to place advertisements based on a given query from the end user, with a much higher degree of relevance. This also exposes the ability to provide dynamic pricing for advertisement monetization based on realtime query signals.

### BACKGROUND

Large amounts of advertising dollars are wasted each year under current models. Advertising revenue can be based on a number of metrics such as cost-per-thousand impressions, cost-per-click, cost-per-action, click-through rates, and so on. The “holy grail” of search engine advertising is to find ways to increase the efficiency of this marketing expenditure.

Existing search engine advertisements for search result pages are purchased on the basis of keywords, which is a largely static model. Advertisement buyers engage in running actions for keywords, with popular keywords costing more than less popular keywords (e.g., popular keywords costing several dollars per click-through).

Search engines use algorithms to determine the position of advertisements according to click-through rates, for example. Advertisements with poor click-through rates may be pushed down to the bottom of the first page of search results or onto subsequent pages. Although advertisers may only be paying for click-through actions, the algorithms assigning advertisement positions based on advertisement popularity provide incentives for optimizing keyword selection and other cost control measures.

An advertising campaign typically includes various combinations of these metrics. Numerous attempts have been made to improve the targeting algorithm so that search engines can be more accurate with match advertising with web index keywords. However, these algorithms, though effective, have a significant chance of leaked resources.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables the realtime selection and application of advertisements to search result of a used based on user query intent. The architecture enables information exchange between a search engine and advertisement frameworks to provide significant input for realtime advertising decisions. Based on this information exchange, query intent provides advertisement buyers (e.g., merchants and partners) a basis from which to select and apply realtime advertisements to search results that cater to the user intent. This also exposes the ability to provide dynamic pricing for advertisement monetization based on realtime query signals.

Understanding user intent facilitates a way of uniquely returning instant results (e.g., answers) as well as tuning the user experience to surface the most relevant information for the user, including advertisements. Each query coming through the search engine is analyzed and classified for user intent. This realtime intent classification enables merchants to choose to place or not to place advertisements based on a given query from the end user, with a much higher degree of relevance.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system of query classification subscription for the one or more services.

FIG. 3 illustrates a method in accordance with the disclosed architecture.

FIG. 4 illustrates further aspects of the method of FIG. 3.

FIG. 5 illustrates an alternative method in accordance with the disclosed architecture.

FIG. 6 illustrates further aspects of the method of FIG. 5.

FIG. 7 illustrates a block diagram of a computing system that executes realtime advertisement processing in accordance with the disclosed architecture.

### DETAILED DESCRIPTION

Search engines are becoming more effective and performant at deciphering user intent. For example, if the query is a shopping query, it is beneficial to decide whether the user is simply researching or actually ready to purchase a product. This information is pivotal for the advertising business. If the user is only researching a product, then an advertisement providing similar products, or deals on product lines is a much better user engagement than an outright sale advertisement.

In the existing search engine online advertising space there is no single solution that provides this level of detail, confidence, and control to the advertisers, thereby providing the advertisers with a high level of confidence in reaching the target audience.

The disclosed architecture provides businesses and advertisement buyers with the flexibility to choose to place or not to place an advertisement based on a given user query. The architecture creates and extends the existing search application frameworks to enable business advertisement decision software to receive input signals (e.g., classification data, query entities etc.) and then provide a response to the search engine as to whether to place an advertisement. The business logic is coded by individuals businesses (denoted generally herein as services).

The architecture consolidates the business advertisement requests and orders the requests to determine which advertisement(s) are selected for presentation on the search engine results page (SERP) with the search results. This extends to business owners a creative and more profitable way to reach the customers whose query intent matches the given business model, rather than buying keywords, as performed conventionally.

Every query input to the search engine is analyzed and classified for user intent. Understanding user intent enables a more focused response to the user as well as tweaking of the user experience to return the most relevant information for the user. Accordingly, understanding the query intent provides a way for merchants and partners to provide realtime advertisements that cater to user intent.

Business advertising campaigns are currently implemented offline for a future search. The disclosed architecture changes this existing paradigm to an online business model. Advertising campaigns are a realtime service that is semi-aware of the business marketing campaigns.

The user's query intent is communicated to advertisers in realtime. Providing the ability to channel the intent to the advertisers adds accuracy to targeted advertising. Moreover, off-loading, the decision making to the advertisers empowers the advertisers to program their campaign on a combination of user intent and keyword matching. Thus, advertisers now have granular control over the cost of the advertisement as well as confidence that reaching the targeted audience is obtained.

Reference is now made to the drawings, wherein like reference numerals are used to refer to like elements throughout. In the following description, for purposes of explanation, numerous specific details are set forth in order to provide a thorough understanding thereof. It truly be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

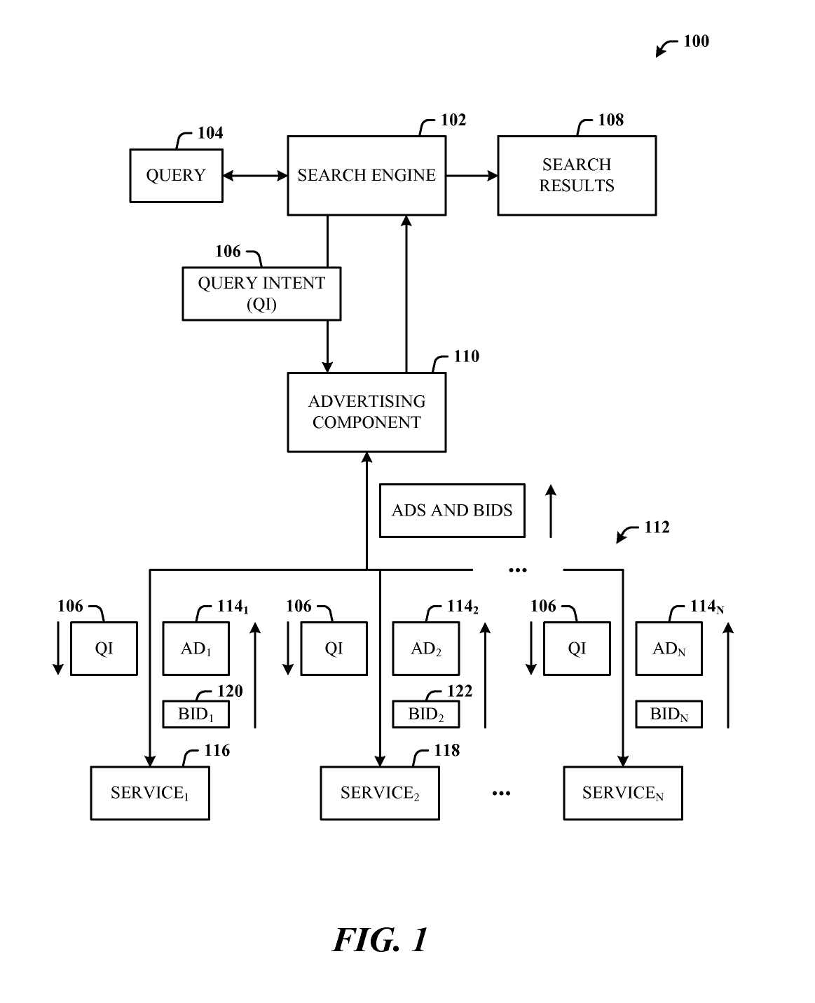

FIG. 1 illustrates a system 100 in accordance with the disclosed architecture. The system 100 can include a search engine 102 that processes a query 104 to derive query intent (QI) 106 and returns search results 108 based on the query intent 106. The system 100 also comprises an advertising component 110 that communicates the query intent 106 to one or more services 112 and receives advertisements 114_{1-N} (generally as label 114) from the one or more services 112 based on the query intent 106 as processed by the individual services 112. In other words, the advertising component 110 sends the query intent 106 to a first service 116, which can be a business or business proxy that subscribes to provide advertisements to the specific type of query intent. The first service 116 responds with a specific advertisement 114₁. Similarly, the advertising component 110 sends the query intent 106 to other services that subscribe to have the opportunity to send advertisements for the specific type of query intent 106. An advertisement is selected for and presented with the search results. The query intent, advertisement selection, and presentation with the search results can all be performed in realtime.

If the query intent 106 derived is hamburgers, the first service 116 can be a fast-food burger vendor, or a restaurant, for example, that sends a particular advertisement 114₁ for its type of hamburger back to the advertising component 110. Similarly, a second service 118 can be a different fast-food burger vendor, or a restaurant, for example, that sends a particular advertisement 114₂ for its type of hamburger back to the advertising component 110. This continues for all subscribing services that respond within a predetermined time period such that this process occurs in realtime (e.g., minimal delay, if any delay at all, as detected by the system and/or the user).

In realtime, the advertising component 110 receives the advertisements from the services 112, and makes a decision as to which advertisement(s) to select and present with the search results 108. In one implementation, the decision (determination) is made based on a bid process where each service responding to the query intent 106 not only sends a suitable advertisement, but also accompanies the advertisement with a bid for the space on the results page in which the selected advertisement will be presented. Thus, the first service 116 sends a bid 120 along with its proposed advertisement 114₁, the second service 118 sends a bid 122 along with its proposed advertisement 114₂, and so on.

This response of advertisements (e.g., advertisements 114₁, 114₂, etc.) and bids (e.g., bids 120, 122, etc.) are then received and processed by the advertisement component 110. This processing includes ranking the bids and selecting the top bid, for example, for the advertising space on the results page.

It can be the case that other or additional criteria can be employed in this selection process separately from or in combination with the highest bid. For example, one criterion can be the vendor location, such that only vendors in the immediate location of the user are considered for advertisement selection and placement. If the user is in a vehicle looking for a hamburger place, it may be counterproductive for the vendor as well as the user to be presented with an advertisement that requires the user to travel more than one hour, rather than a vendor location ten minutes away from the current location of the user. Other criteria can include traffic conditions, time of day, weather conditions, day of the week, holidays, special events such as birthdays, user profile information, user allergies, customer reviews, etc.

An advertisement is selected for and presented with the search results 108; the query intent 106, advertisement selection, and presentation with the search results 108, are all performed in realtime.

In other words, the query intent 106 is analyzed and classified into a query intent classification. The advertising component 110 enables subscription of a service to a specific query intent classification, and a subscribing vendor service responds to the advertising component 110 based on a received specific query intent classification. The advertising component 110 also receives a bid from the one or more services for determining presentation of the advertisement on a search results page. The bid is processed in realtime with the query intent, advertisement selection, and advertisement presentation with the search results. The advertising component 110 receives multiple bids from multiple corresponding services 112 and ranks the bids for selection of a top bid and associated advertisement. The advertising component 110 aggregates all advertisements 114 from the one or more services 112, and selects an advertisement based on selection criteria. The advertising component 110 sends the query intent 106 and classification confidence level data to each of the one or more services 112 subscribing to the query intent 106. The advertising component 110 can serve up advertisements based on an optimized price-to-relevance computation.

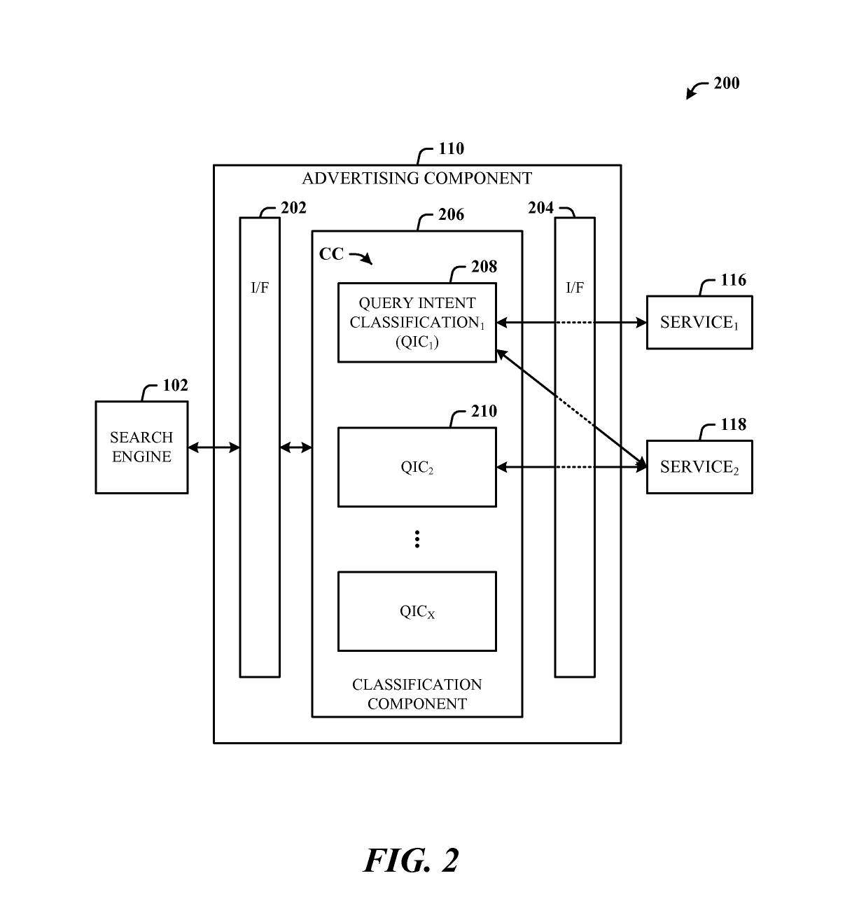

FIG. 2 illustrates a system 200 of query classification subscription for the one or more services. The advertising component 110 can be an entity separate from the search engine 102, or embodied as part of the search engine 102. In any case, the advertising component 110 can include a search engine interface 202 for communicating data and instructions to and from the search engine 102, such as for passing advertisements to the search engine 102 for rendering in association with the search results. Similarly, a services interface 204 is provided that communicates query intent information, classification information, keyword information, subscription information (e.g., to verify subscription) to the services (e.g., service 116 and service 118), and receives bids, advertisements, and other related information from the services.

Additionally, internal to the advertising component 110 can be a classification component 206 that enables classification handling and subscription, for the services (e.g., service 116 and service 118) to specific query intent classifications (QICs). Here, the first service 116 subscribes to a first QIC 208, and the second service 118 subscribes to the first QIC 208 and a second QIC 210. Thus, when query intent, as derived by the search engine 102, is classified as the first QIC 208, with some degree of confidence, both the first service 116 and the second service 118 are notified to respond with bids and advertisements that correspond to the query intent. On the other hand, if the query intent is classified as the second QIC 210, with some degree of confidence, only the second service 118 is notified and given the opportunity to respond with a bid and an advertisement, since the first service is not a subscriber to the second QIC 210.

The entities associated with the services, such as vendors, merchants, businesses, advertisement providers that act as proxy for the vendors, partners, and so on, can then write custom code as part of their service to employ the desired functionality to and from the advertisement component 110. Similarly, the different kinds of available search engines can develop customized code for interfacing to the advertising component 110 to obtain the benefits associated therewith.

The following description is specific to the Bing™ (by Microsoft Corporation) search framework, and is to be considered only one example of implementing the disclosed framework. The Bing realtime ads (short for advertisements) host service (RTAS) consolidates the bids, and orders (e.g., ranks) the highest bids (e.g., the top ten highest bids for the given query). Signals are then sent back to the user experience via an answer top-level aggregator (ATLA) to render the “winning” advertisements. This provides business owners with a creative and more profitable way to reach the customers whose query intent matches their business model, rather than needing to purchase keywords.

More specifically, within the Bing search engine stack, each query is analyzed and classified by a query analysis system (QAS). The QAS receives signals from the RTAS as input.

Each merchant or partner can host a custom ads service (business ads service (BAS)), as desired. Each of the BAS can be architected on a plug-in model, and provides the merchant/partner the ability to subscribe to a particular query intent classification. For instance, an online shopping merchant can host a service that subscribes to shopping intent queries, and an online travel merchant can a service that subscribes to travel intent queries.

For each classified query, the RTAS provides information to each of the BAS instances (subscribing services or merchants) on the query intent and classification confidence level. Each BAS instance implements logic to provide a price bid fir advertisement(s) provided by that merchant, based on query classification, query intent, and the merchant/partners individual advertisement campaigns and programs. The BAS instance also provides the merchant/partner the capability to serve up customized advertisements that adhere to individual campaigns and marketing initiatives. RTAS prioritizes BAS responses and can serve up advertisements based on optimized price-to-relevance calculation.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

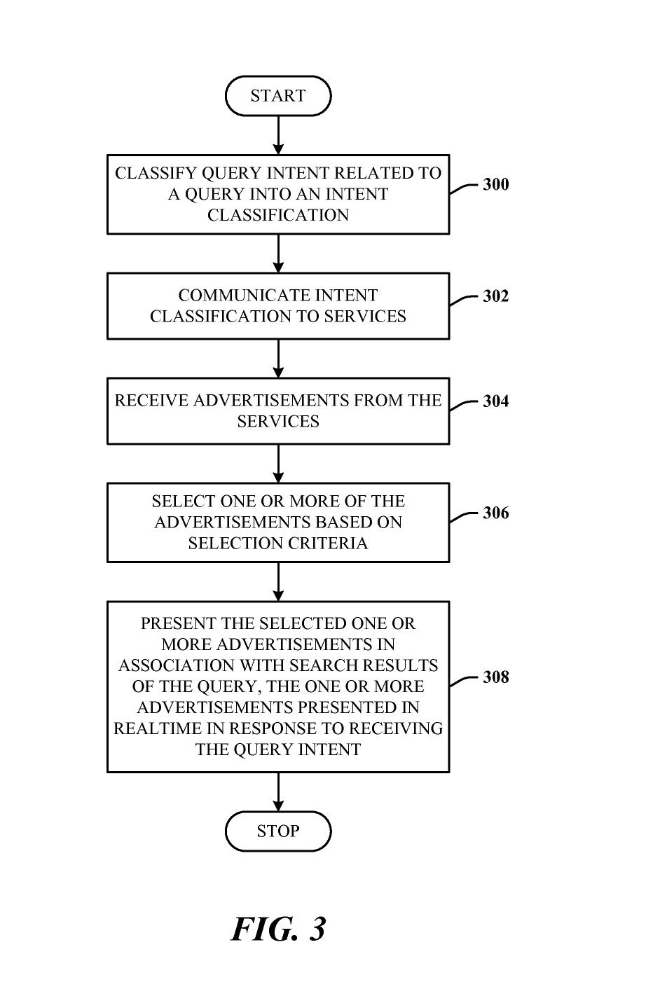

FIG. 3 illustrates a method in accordance with the disclosed architecture. At 300, query intent related to a query is classified into an intent classification. At 302, the intent classification is communicated to the services. At 304, advertisements are received from the services. At 306, one or more of the advertisements are selected based on selection criteria (e.g., highest bid). At 308, the selected one or more advertisements are presented in association with search results of the query. The one or more advertisements are presented in realtime in response to receiving the query intent.

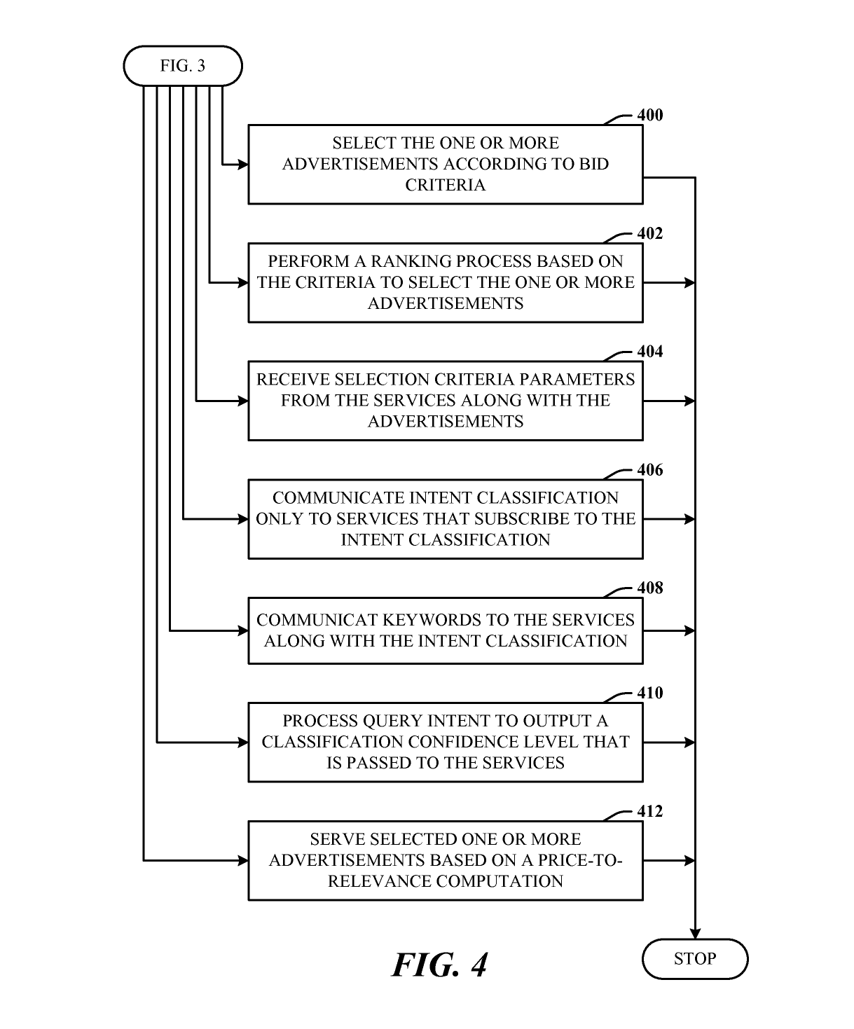

FIG. 4 illustrates further aspects of the method of FIG. 3. Note that the flow indicates that each block can represent a step that can be included, separately or in combination with other blocks, as additional aspects of the method represented by the flow chart of FIG. 3. At 400, the one or more advertisements (e.g., image, text, video, etc.) are selected according to bid criteria highest bid). At 402, a ranking process is performed based on the criteria to select the one or more advertisements. At 404, selection criteria parameters (e.g., bid prices) are received from the services along with the advertisements. In other words, selection can be based on what the criteria parameters are, such as bid price. At 406, the intent classification is communicated only to services that subscribe to the intent classification. At 408, keywords are communicated to the services along with the intent classification. At 410, the query intent is processed to output a classification confidence level that is passed to the services. At 412, the selected one or more advertisements are served up based on a price-to-relevance computation.

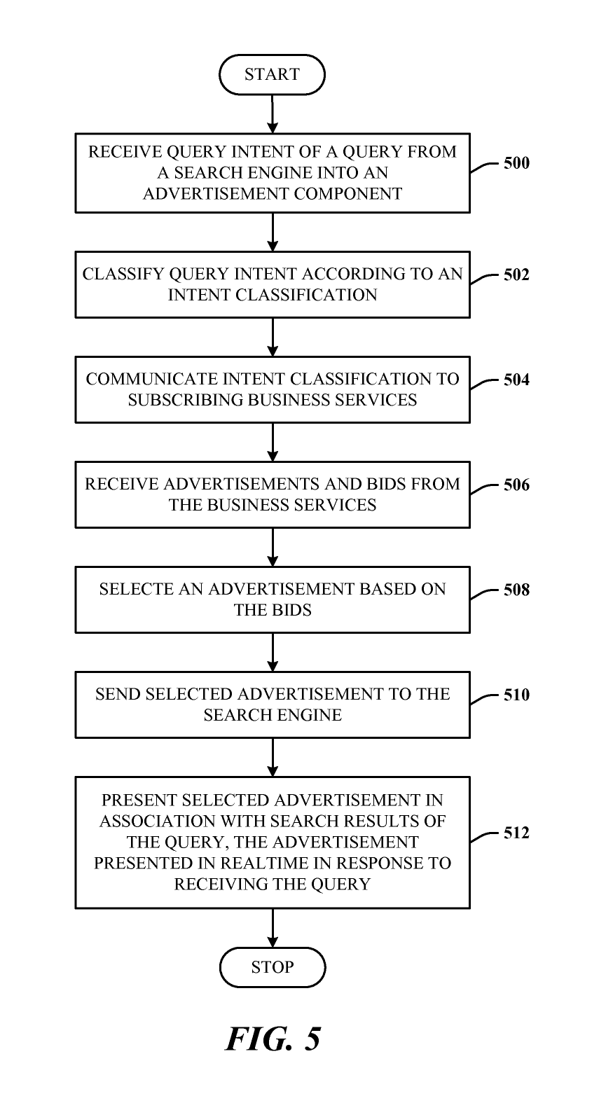

FIG. 5 illustrates an alternative method in accordance with the disclosed architecture. At 500, query intent of a query is received from a search engine into an advertisement component. At 502, the query intent is classified according to an intent classification. At 504, the intent classification is communicated to subscribing business services. At 506, advertisements and bids are received from the business services. At 508, an advertisement is selected based on the bids. At 510, the selected advertisement is sent to the search engine. At 512, the selected advertisement is presented in association with search results of the query. The advertisement is presented in realtime in response to receiving the query.

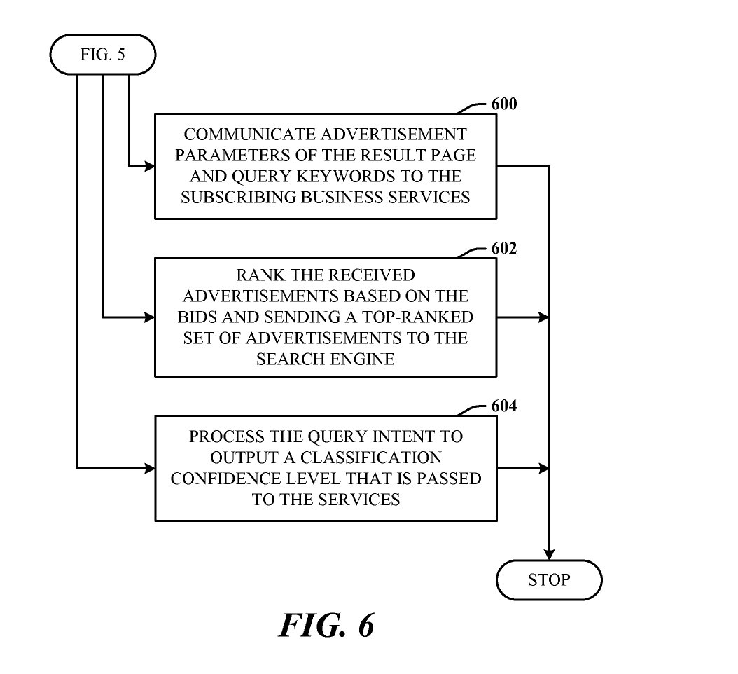

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, advertisement parameters (e.g., file size, dimensions, media type, etc.) of the result page and query keywords (from the query) are communicated to the subscribing business services. At 602, the received advertisements are ranked based on the bids and a top-ranked set of advertisements is sent to the search engine. At 604, the query intent is processed to output a classification confidence level that is passed to the services.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

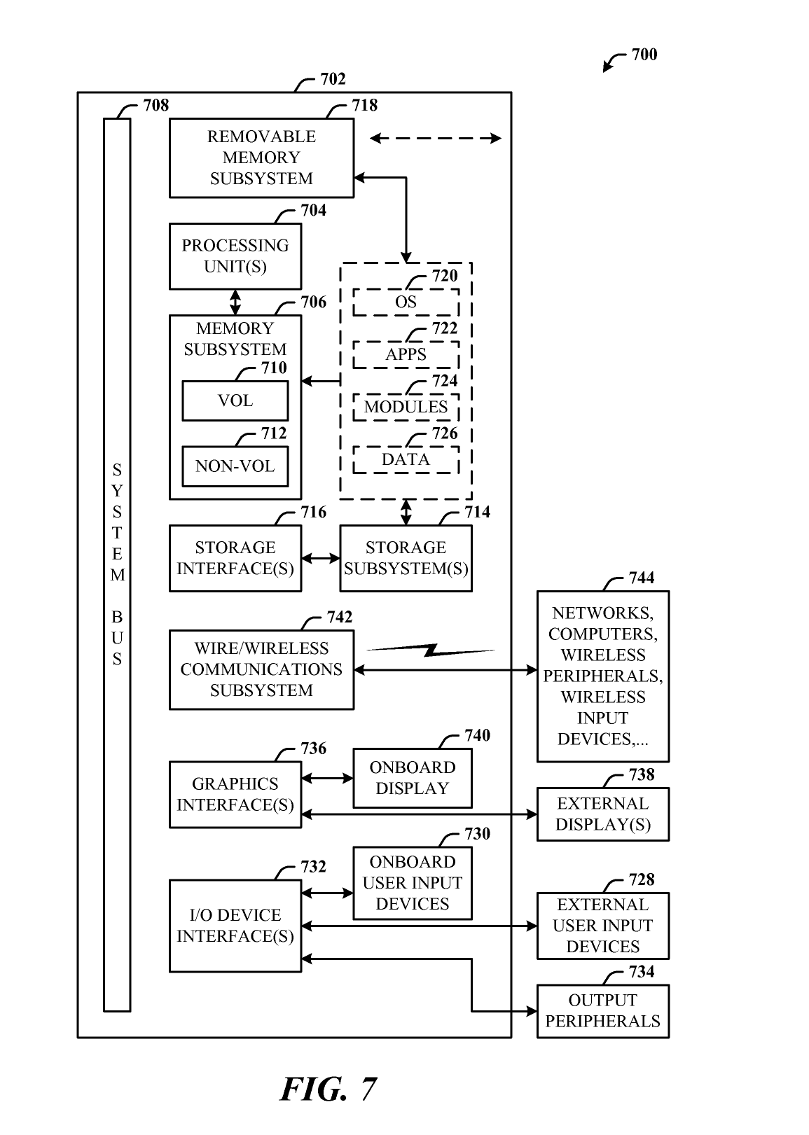

Referring now to FIG. 7, there is illustrated a block diagram of a computing system 700 that executes realtime advertisement processing in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc), hand-held computing devices, microprocessor-based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the system 200 of FIG. 2, and the methods represented by the flowcharts of FIGS. 3-6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 702 and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example. These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on, LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a search engine that processes a query to derive query intent and returns search results based on the query intent;
an advertising component that communicates the query intent to one or more services and receives advertisements from the one or more services based on the query intent, an advertisement selected for and presented with the search results; the query intent, advertisement selection, and presentation with the search results all performed in realtime; and
a processor that executes computer-executable instructions associated with at least the advertising component.

2. The system of claim 1, wherein the query intent is analyzed and classified into a query intent classification.

3. The system of claim 2, wherein the advertising component enables subscription of a service to a specific query intent classification and a subscribing vendor service responds to the advertising component based on a received specific query intent classification.

4. The system of claim 1, wherein the advertising component also receives a bid from the one or more services for determining presentation of the advertisement on a search results page, the bid processed in realtime with the query intent, advertisement selection, and advertisement presentation with the search results.

5. The system of claim 1, wherein the advertising component receives multiple bids from multiple corresponding services and ranks the bids for selection of a top bid and associated advertisement.

6. The system of claim 1, wherein the advertising component aggregates all advertisements from the one or more services, and selects an advertisement based on selection criteria.

7. The system of claim 1, wherein the advertising component sends the query intent and classification confidence level data to each of the one or more services subscribing to the query intent.

8. The system of claim 1, wherein the advertising component serves up advertisements based on an optimized price-to-relevance computation.

9. A method, comprising acts of:
classifying query intent related to a query into an intent classification;
communicating the intent classification to services;
receiving advertisements from the services;
selecting one or more of the advertisements based on selection criteria;
presenting the selected one or more advertisements in association with search results of the query, the one or more advertisements presented in realtime in response to receiving the query intent; and
utilizing a processor that executes instructions stored in memory to perform at least one of the acts of classifying, communicating, receiving, selecting, or presenting.

10. The method of claim 9, further comprising selecting the one or more advertisements according to bid criteria.

11. The method of claim 9, further comprising performing a ranking process based on the criteria to select the one or more advertisements.

12. The method of claim 9, further comprising receiving selection criteria parameters from the services along with the advertisements.

13. The method of claim 9, further comprising communicating the intent classification only to services that subscribe to the intent classification.

14. The method of claim 9, further comprising communicating keywords to the services along with the intent classification.

15. The method of claim 9, further comprising processing the query intent to output a classification confidence level that is passed to the services.

16. The method of claim 9, further comprising serving the selected one or more advertisements based on a price-to-relevance computation.

17. A method, comprising acts of:
receiving query intent of a query from a search engine into an advertisement component;
classifying the query intent according to an intent classification;
communicating the intent classification to subscribing business services;
receiving advertisements and bids from the business services;
selecting an advertisement based on the bids;
sending the selected advertisement to the search engine;
presenting the selected advertisement in association with search results of the query, the advertisement presented in realtime in response to receiving the query; and
utilizing a processor that executes instructions stored in memory to perform at least one of the acts of receiving the query intent, classifying, communicating, receiving advertisements, selecting, sending, or presenting.

18. The method of claim 17, further comprising communicating advertisement parameters of the result page and query keywords to the subscribing business services.

19. The method of claim 17, further comprising ranking the received advertisements based on the bids and sending a top-ranked set of advertisements to the search engine.

20. The method of claim 17, further comprising processing the query intent to output a classification confidence level that is passed to the services.
